(19) United States
(12) Patent Application Publication
(10) Pub. No.: US 2017/0038513 A1
(43) Pub. Date: Feb. 9, 2017

(54) OPTICAL APPARATUS

(71) Applicant: EVERREADY PRECISION IND. CORP., Kaohsiung City (TW)

(72) Inventors: JYH-LONG CHERN, Taipei City (TW); CHIH-MING YEN, New Taipei City (TW)

(21) Appl. No.: 14/884,304

(22) Filed: Oct. 15, 2015

(30) Foreign Application Priority Data
Aug. 7, 2015 (TW) 104125787

(51) Int. Cl. F21V 8/00; G02B 6/26

(52) U.S. Cl. CPC G02B 6/0008; G02B 6/26

(57) ABSTRACT

An optical apparatus includes a structured light generation unit, at least one light transmission element and an optical coupler. The structured light generation unit outputs a structured light. Plural first light beams of the structured light are introduced into the light transmission element and transferred within the light transmission element. The structured light generation unit and the at least one light transmission element are coupled with each other through the optical coupler. The optical apparatus has increased optical coupling efficiency and reduced volume.

### FIELD OF THE INVENTION

The present invention relates to an optical apparatus, and more particularly to an optical apparatus with a light transmission element for uniform illumination.

### BACKGROUND OF THE INVENTION

Recently there are emergent applications of special lighting to a variety of fields with the light emitting diode (LED), e.g., LED general lighting, LED indoor lighting, security lighting, lighting embedded in fiber web or texture. On the other hand, laser diode (LD) is seldom to be employed in the fields mentioned above, comparing with LED. However, the light source of LD is always brighter than LED which has its uniqueness and advantage in illumination application. On the other hand, it has been well known that with LD, a longer transmission range with uniform illuminance is available, particularly when there is good medium for propagation.

Optical fiber is such a light transmission tool and generally, the optical fiber is made of glass or plastic material. The light beam can be transferred within the optical fiber by total reflection. Since optical fibers have many benefits such as low loss, high bandwidth, light weightiness, small size and non-conductivity, optical fibers are gradually applied to a communication field, a medical field and an entertainment field. For example, an optical fiber that is installed in a clothing to transmit optical signals within the clothing has been disclosed in US Patent Publication No. 2011/0069974. Moreover, the HALO BELT® wearable device (e.g., a belt or a back brace) is equipped with a light diffusion fiber (LDF) for providing a warning and lighting function. When the wearable devices are worn by the users (especially elder people, younger people, women, children or those who are exercising), the traffic safety for the users will be enhanced. In other words, with proper medium, a light illuminating with LD could be superior in many aspects.

However, there are at least three drawbacks for the device using the optical fiber in current days. Firstly, since the optical coupling between the light source (i.e., the device for providing light beams) and the optical fiber is low, the light utilization efficiency is usually unsatisfied. Secondly, since the size of the optical fiber connector for coupling the light source and the optical fiber is too large and occupies a lot of space, the device using the optical fiber is not suitably applied to the wearable product (especially the application in small size, light weightiness and slimness). Thirdly, the conventional technology uses lenses to converge the light beams from light source and then introduces the light beams into the optical fiber. Since the lens has a certain thickness, the overall volume of the device using the optical fiber cannot be effectively reduced. That is, the device using the optical fiber is not well suitably applied to the wearable product yet. On the other hand, the current applications in daily 3C device and even clothing and dressing, is very different from that of optical communication. We may need different colors (red, green, and blue) in mixing in one fiber while in optical communication it is IR signal mainly.

From the above illustrations, the applications of the current optical fibers with LD need to be further improved.

### SUMMARY OF THE INVENTION

For solving the drawbacks of the conventional technology, the present invention provides an optical apparatus with enhanced optical coupling efficiency and reduced volume.

In accordance with an aspect of the present invention, there is provided an optical apparatus. The optical apparatus includes a structured light generation unit, at least one light transmission element and an optical coupler. The structured light generation unit outputs a structured light. After plural first light beams of the structured light are introduced into the light transmission element, the plural first light beams are transferred within the light transmission element. The structured light generation unit and the at least one light transmission element are coupled with each other through the optical coupler.

In an embodiment, the structured light generation unit includes a light source and an optical element group. The optical element group includes a diffractive optical element (DOE), a refractive optical element and/or a reflective optical element. The light source provides plural second light beams. The structured light is generated after the plural second light beams pass through the optical element group.

In an embodiment, the diffractive optical element (DOE) has a single-layered substrate, or the diffractive optical element includes plural substrates in a stack arrangement.

In an embodiment, the diffractive optical element includes at least one optical diffractive film.

In an embodiment, a travelling direction of the plural second light beams is guided by the diffractive optical element (DOE), so that the plural second light beams are outputted from a corresponding outlet of a corresponding surface of the diffractive optical element.

In an embodiment, the light source at least includes at least one light-emitting unit, and the at least one light-emitting unit includes a laser diode (LD), a light emitting diode (LED) and/or an organic light emitting diode (OLED).

In an embodiment, the at least one light-emitting unit and the at least one light transmission element are in a one-to-one optical coupling arrangement, a one-to-multiple optical coupling arrangement or a multiple-to-multiple optical coupling arrangement.

In an embodiment, the plural second light beams from the light source have wavelengths in a first wavelength range, a second wavelength range and/or a thermal band.

In an embodiment, the light source includes an organic light emitting diode with plural lighting blocks, and the plural second light beams include different color beams corresponding to the plural lighting blocks. The diffractive optical element includes plural guiding blocks. After the plural second light beams are introduced into the diffractive optical element, the plural second light beams are guided by the corresponding guiding blocks along different optical paths and outputted from different positions of the diffractive optical element.

In an embodiment, he at least one light transmission element includes at least one optical fiber.

In an embodiment, the optical apparatus further includes a heat treatment structure. The heat generated from the optical apparatus is dissipated by convection, conduction and/or radiation through the heat treatment structure.

In an embodiment, the heat generated from the optical apparatus is dissipated by convection through the heat treatment structure according to Bernoulli's principle.

In an embodiment, the heat treatment structure includes a first airflow port and a second airflow port, wherein a total area of the first airflow port and a total area of the second airflow port are different.

In an embodiment, the heat treatment structure includes a thermal conduction part, and the heat generated from the optical apparatus is dissipated by conduction through the thermal conduction part. Moreover, a thickness of the thermal conduction part is equal to or smaller than 15 mm.

In an embodiment, the heat treatment structure includes at least one thermal radiation part. The heat generated from the optical apparatus is dissipated by radiation through the thermal radiation part.

In an embodiment, the optical apparatus is applied to a communication field, a security field, an entertainment field and/or a medical field.

In an embodiment, the optical apparatus is a wearable device.

From the above descriptions, the present invention provides the optical apparatus. When light beams are introduced into the light transmission element, the light beams have been shaped by the structured light generation unit. Consequently, the components between the light source and the light transmission element can be deployed more flexibly. Moreover, since the thickness of the diffractive optical element is very small according to the conventional technology, the use of the diffractive optical element in the optical apparatus can reduce the optical loss during light transmission and increase the optical coupling between the light source and the light transmission element. Under this circumstance, the volume or the optical coupler for coupling the light source and the light transmission element and the overall volume of the optical apparatus are effectively reduced. In other words, since the use of the diffractive optical element can generate verified structured light patterns, more flexible optical coupling ways can be provided. In addition, the optical coupling efficiency is increased, and the overall volume of the optical apparatus is flexibly adjusted or reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating an optical apparatus according to a first embodiment of the present invention;

FIG. 2 is a schematic view illustrating a structured light generation unit of the optical apparatus of FIG. 1;

FIG. 3A is a schematic top view illustrating a structured light generation unit of an optical apparatus of according to a second embodiment of the present invention;

FIG. 3B is a schematic front view illustrating the structured light generation unit of FIG. 3A;

FIG. 4 is a schematic view illustrating an optical apparatus of according to a third embodiment of the present invention;

FIG. 5 is a schematic view illustrating a structured light outputted from a structured light generation unit of the optical apparatus of FIG. 4;

FIG. 6A schematically illustrates a stripe-like pattern of the structured light from the structured light generation unit;

FIG. 6B schematically illustrates a vortex ring pattern of the structured light from the structured light generation unit;

FIG. 6C schematically illustrates the grid pattern of the structured light from the structured light generation unit;

FIG. 6D schematically illustrates a multiple-stripe pattern of the structured light from the structured light generation unit;

FIG. 6E schematically illustrates a multiple-dot pattern of the structured light from the structured light generation unit;

FIG. 6F schematically illustrates a rectangular-plane pattern of the structured light from the structured light generation unit;

FIG. 7 is a schematic view illustrating an optical apparatus of according to a fourth embodiment of the present invention;

FIG. 8 is a schematic view illustrating a structured light generation unit of an optical apparatus according to a fifth embodiment of the present invention;

FIG. 9 is a schematic view illustrating a light source of the structured light generation unit of FIG. 8, in which the light source is an organic light emitting diode (OLED);

FIG. 10 is a schematic view illustrating a structured light generation unit of an optical apparatus according to a sixth embodiment of the present invention;

FIG. 11 is a schematic view illustrating the guided optical paths in the diffractive optical element of FIG. 10;

FIG. 12 is a schematic view illustrating a structured light generation unit of an optical apparatus according to a seventh embodiment of the present invention; and

FIG. 13 is a schematic view illustrating an optical apparatus according to an eighth embodiment of the present invention.

### DETAILED DESCRIPTION OF THE PREFERRED EMBODIMENT

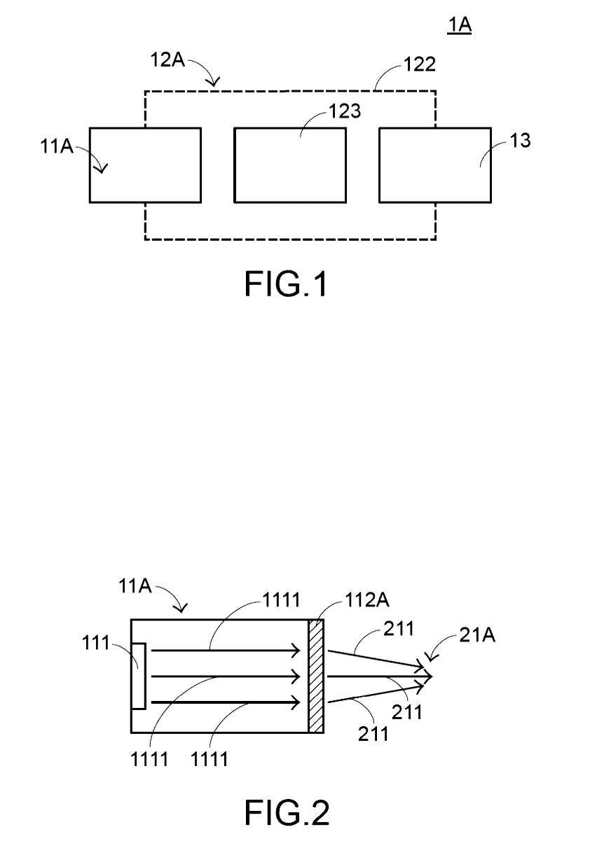

FIG. 1 is a schematic functional block diagram illustrating an optical apparatus according to a first embodiment of the present invention. FIG. 2 is a schematic view illustrating a structured light generation unit of the optical apparatus of FIG. 1. As shown in FIGS. 1 and 2, the optical apparatus 1A comprises a structured light generation unit 11A, an optical coupler 12A and a light transmission element 13. The structured light generation unit 11A is used for generating a structured light 21A. The optical coupler 12A comprises a casing 122 and a coupling unit 123. The coupling unit 123 is disposed within the casing 122. The structured light generation unit 11A and the light transmission element 13 are coupled with each other through the coupling unit 123. Consequently, plural light beams 211 of the structured light 21A from the structured light generation unit 11A can be transferred to the light transmission element 13. Moreover, after the plural light beams 211 of the structured light 21A are introduced into the light transmission element 13, the light beams 211 are transferred with the light transmission element 13 through total reflection. Preferably but not exclusively, the light transmission element 13 is an optical fiber or a light diffusion fiber (LDF) that provides lighting to the outside. The technology of the light diffusion fiber is well known to those skilled in the art (e.g., disclosed by Corning®), and is not redundantly described herein.

In this embodiment, the structured light generation unit 11A comprises a light source 111 and an optical element group. The optical element group comprises a diffractive optical element (DOE) 112A, a refractive optical element and/or a reflective optical element. The light source 111 is used for providing plural light beams 1111. After the plural light beams 1111 pass through the optical element group, the structured light 21A is generated. In this embodiment, after the plural light beams 1111 from the light source 111 pass through the diffractive optical element 112A, the structured light 21A is generated. Alternatively, in another embodiment, the structured light is generated after the plural light beams 1111 from the light source 111 pass through a refractive optical element and a reflective optical element.

Preferably but not exclusively, the diffractive optical element 112A is a flexible optical diffractive film formed on the structured light generation unit 11A. The diffractive optical element 112A is designed according to the practical requirements. In particular, when the light beams 1111 pass through the diffractive optical element 112A, the light beams 1111 are shaped by the diffractive optical element 112A. Consequently, the structured light 21A outputted from the structured light generation unit 11A can be flexibly adjusted. For example, the plural light beams 211 of the structured light 21A can be accurately converged and guided to the light transmission element 13. The ways of designing the diffractive optical element 112A and generating the desired structured light 21A by the diffractive optical element 112A are well known to those skilled in the art, and are not redundantly described herein

Moreover, the diffractive optical element 112A is designed according to the optical diffraction theory. That is, the diffractive optical element 112A is a phase-type optical element. For example, the diffractive optical element 112A is fabricated by a semiconductor processing technology, a direct writing technology, a holographic technology or a point diamond turning technology.

Preferably but not exclusively, the diffractive optical element 112A may satisfy the following mathematic formulae:

$$φ ( r ) = \sum {φ}_{i} , and i = 1 , 2 , … N ;$$

$$where , \\ {r}^{2} = {x}^{2} + {y}^{2} ;$$

$${φ}_{i} = dor \cdot ( \frac{2 π}{λ} ) \cdot {df}_{i} ( {x}^{j} ) ( {y}^{k} ) ;$$

$$i = {( j + k )}^{2} + j + 3 k ;$$

$$j = o - k ;$$

$$k = i - \frac{o \cdot ( o + 1 )}{2} ;$$

$$o = floor [ \frac{\sqrt{1 + 8 i} - 1}{2} ] .$$

In the above mathematic formulae, φ(r) is a phase function, r is a radius vector, dor is the diffraction order, λ is a wavelength of a light beam passing through the diffractive optical element, and dfᵢ is a diffraction coefficient. The above mathematic formula is well known to those skilled in the art, and is not redundantly described herein.

In an embodiment, the light source 111 is a single light-emitting unit. For example, the light-emitting unit comprises a laser diode (LD), a light emitting diode (LED), or any other comparable semiconductor-type light-emitting element similar to the laser diode or the light emitting diode. The wavelengths of the light beams 1111 from the light source 111 are in a first wavelength range and/or a second wavelength range. For example, the light beams 1111 from the light source 111 are visible beams, invisible beams or light beams in a thermal band. Moreover, the light source 111 and the light transmission element 13 are in a one-to-one optical coupling arrangement. That is, the diffractive optical element 112A is specially designed. Consequently, after the light beams 1111 from the light source 111 pass through the diffractive optical element 112A, the structured light 21A is converged to a converged point and then introduced into the light transmission element 13.

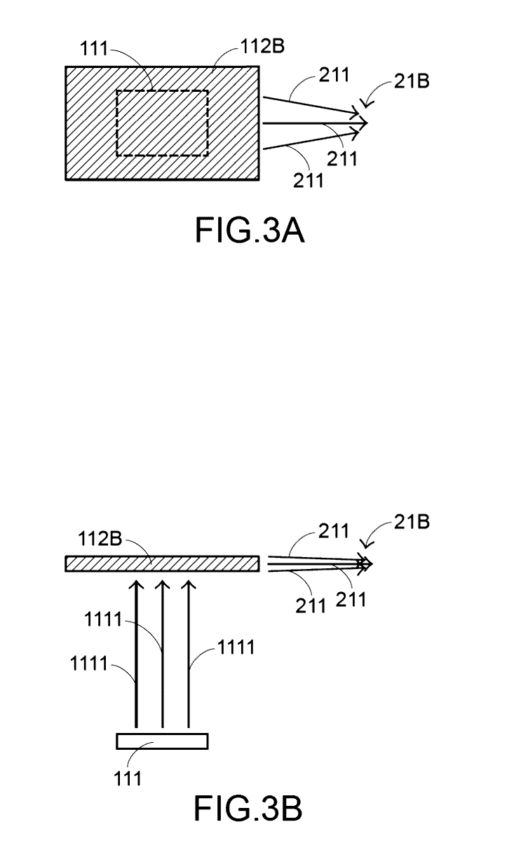

Please refer to FIGS. 3A and 3B. FIG. 3A is a schematic top view illustrating a structured light generation unit of an optical apparatus of according to a second embodiment of the present invention. FIG. 3B is a schematic front view illustrating the structured light generation unit of FIG. 3A. The components of the optical apparatus of this embodiment which are similar to the optical device of the first embodiment are not redundantly described herein. In comparison with the first embodiment, the light source 111 is disposed under the diffractive optical element 112B according to the practical requirements. Moreover, the plural light beams 1111 from the light source 111 travel toward the diffractive optical element 112B in the upward direction. The diffractive optical element 112B is specially designed. Consequently, the after the plural light beams 1111 from the light source 111 are introduced into the diffractive optical element 112B, the travelling direction of the plural light beams is changed. In particular, the plural light beams 1111 are outputted from a lateral side of the diffractive optical element 112B and then introduced into the light transmission element 13. In other words, the diffractive optical element 112B has a light-guiding function.

The use of the diffractive optical element (DOE) to guide the light beams 111 is presented herein for purpose of illustration and description only. It is noted that numerous modifications and alterations may be made while retaining the teachings of the invention. For example, the diffractive optical element is specially designed. Consequently, after the plural light beams 1111 from the light source 111 are introduced into the diffractive optical element, the travelling direction of the plural light beams is changed. Moreover, the plural light beams 1111 are outputted from an outlet of a predetermined surface (e.g., any surface) of the diffractive optical element, and thus the structured light is generated.

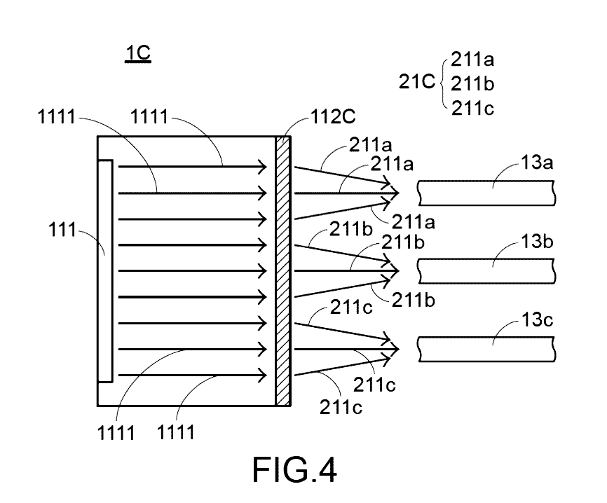

Please refer to FIGS. 4 and 5. FIG. 4 is a schematic view illustrating an optical apparatus of according to a third embodiment of the present invention. FIG. 5 is a schematic view illustrating a structured light outputted from a structured light generation unit of the optical apparatus of FIG. 4. The components of the optical apparatus 1C of this embodiment which are similar to the optical devices of the first embodiment and the second embodiment are not redundantly described herein. For clearly describing this embodiment, some components of the optical apparatus 1C are not shown in FIG. 4.

In comparison with the first embodiment and the second embodiment, the optical apparatus 1C comprises plural light transmission elements 13a, 13b and 13c. Moreover, the light-emitting unit of the light source 111 and the plural light transmission elements 13a˜13c are in a one-to-multiple optical coupling arrangement. As shown in FIG. 4, the light-emitting unit of the light source 111 and the plural light transmission elements 13a˜13c are in a one-to-three optical coupling arrangement. That is, the diffractive optical element 112C is specially designed. Consequently, after the light beams 1111 from the light source 111 pass through the diffractive optical element 112C, the structured light 21C is converged to plural converged points and the light beams 211a˜211c are respectively introduced into the light transmission elements 13a˜13c. For example, the light beams 211a are introduced into the light transmission element 13a, the light beams 211b are introduced into the light transmission element 13b, and the light beams 211c are introduced into the light transmission element 13c.

The structured light 21C with three converged points are presented herein for purpose of illustration and description only. In case that the light-emitting unit of the light source and the plural light transmission elements are in the one-to-multiple optical coupling arrangement, the diffractive optical element is specially designed. Consequently, the structured light outputted from the structured light generation unit has various patterns in order to meet the practical requirements.

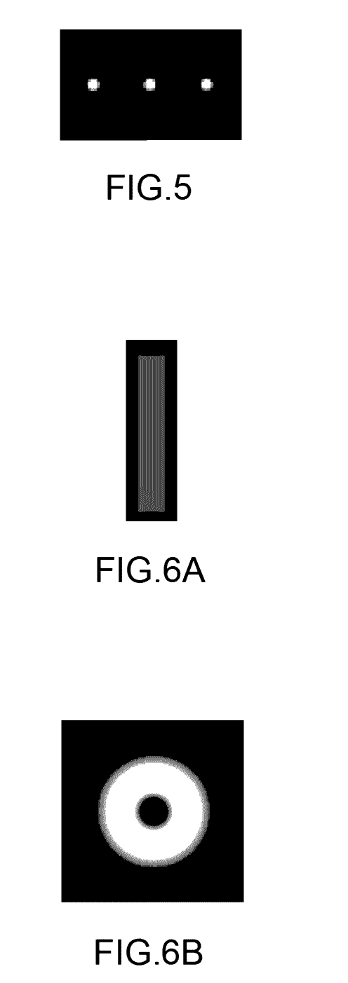

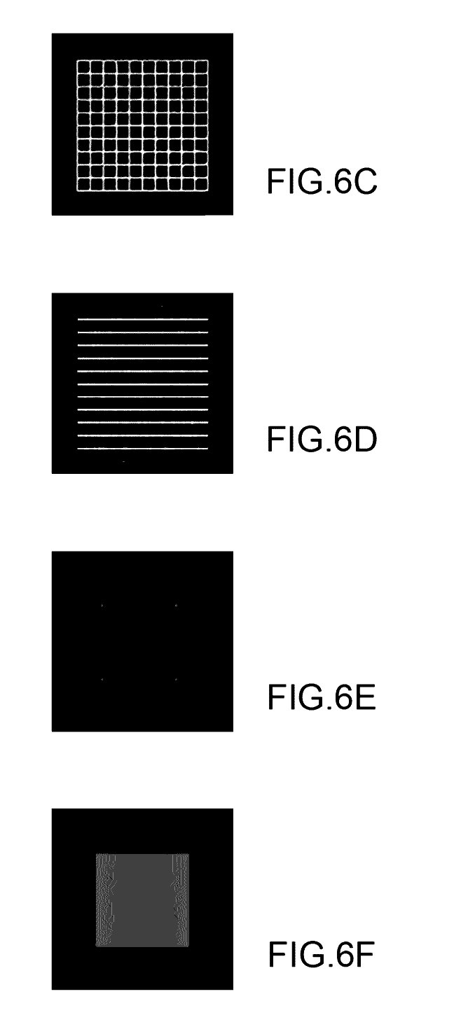

FIGS. 6A˜6F schematically illustrate six exemplary structured light patterns. It is noted that the examples of the structured light patterns are not restricted. FIG. 6A schematically illustrates a stripe-like pattern of the structured light from the structured light generation unit. FIG. 6B schematically illustrates a vortex ring pattern of the structured light from the structured light generation unit. FIG. 6C schematically illustrates the grid pattern of the structured light from the structured light generation unit. FIG. 6D schematically illustrates a multiple-stripe pattern of the structured light from the structured light generation unit. FIG. 6E schematically illustrates a multiple-dot pattern of the structured light from the structured light generation unit. FIG. 6F schematically illustrates a rectangular-plane pattern of the structured light from the structured light generation unit.

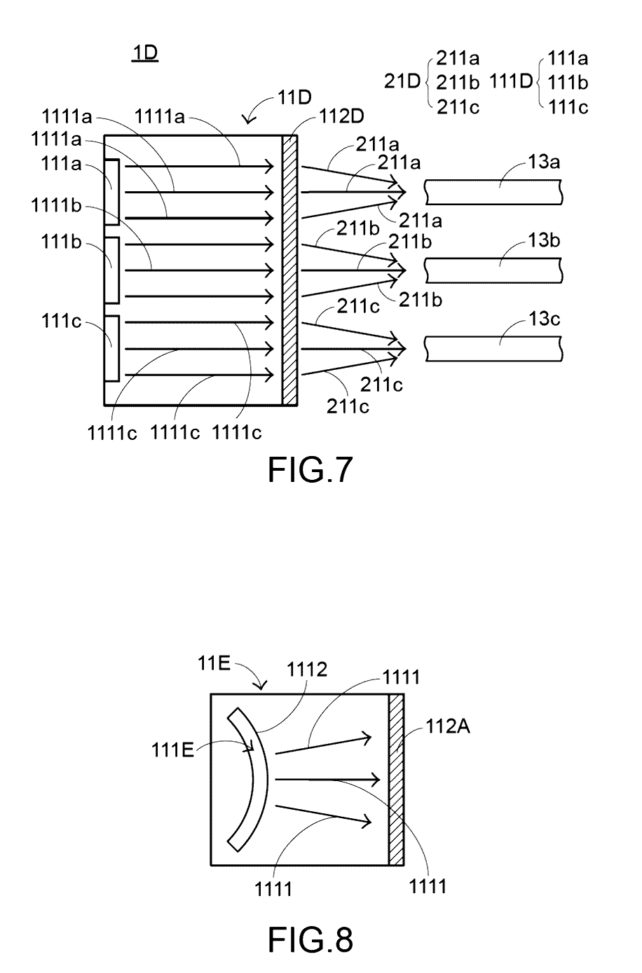

FIG. 7 is a schematic view illustrating an optical apparatus of according to a fourth embodiment of the present invention. The components of the optical apparatus 1D of this embodiment which are similar to the optical devices of the above embodiments are not redundantly described herein. For clearly describing this embodiment, some components of the optical apparatus 1D are not shown in FIG. 7.

In comparison with the above embodiments, the light source 111D comprises plural light-emitting units 111˜111c. The light-emitting units 111˜111c are in a regular arrangement (e.g., in an array arrangement) or in an irregular arrangement. Moreover, each of the light-emitting units 111˜111c comprises a laser diode (LD), a light emitting diode (LED), or any other comparable semiconductor-type light-emitting element similar to the laser diode or the light emitting diode. The wavelengths of the light beams 1111a˜1111c from the light-emitting units 111˜111c are in a first wavelength range and/or a second wavelength range.

Moreover, the optical apparatus 1D comprises plural light transmission elements 13a, 13b and 13c. The light-emitting units of the light source 111D and the plural light transmission elements 13a˜13c are in a multiple-to-multiple optical coupling arrangement. As shown in FIG. 7, the light-emitting units 111˜111c of the light source 111D and the plural light transmission elements 13a˜13c are in a three-to-three optical coupling arrangement. That is, the diffractive optical element 112D is specially designed. Consequently, after the light beams from the light-emitting units 111˜111c pass through the diffractive optical element 112D, the structured light 21D is converged to plural converged points and the light beams 211a˜211c are respectively introduced into the light transmission elements 13a˜13c.

In case that the light-emitting units of the light source and the plural light transmission elements are in the multiple-to-multiple optical coupling arrangement, the diffractive optical element 112D may be specially designed. Consequently, the structured light 21D outputted from the structured light generation unit 11D has various patterns in order to meet the practical requirements. Preferably but not exclusively, the patterns of the structured light 21D are those shown in FIGS. 5 and 6A-6F. Moreover, in case that the plural light-emitting units 111˜111c provide a read beam, a green beam and a blue beam, the structured light 21D outputted from the structured light generation unit 11D has a mixed color.

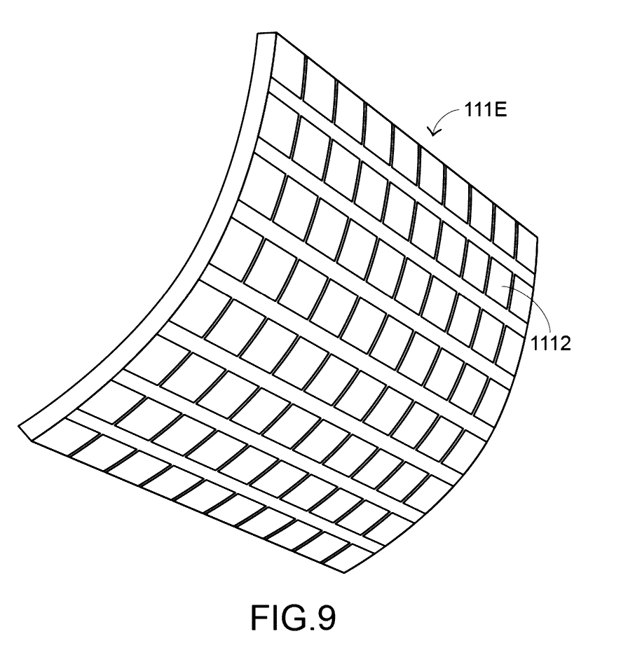

FIG. 8 is a schematic view illustrating a structured light generation unit of an optical apparatus according to a fifth embodiment of the present invention. The components of the optical apparatus of this embodiment which are similar to the optical devices of the above embodiments are not redundantly described herein. In comparison with the above embodiments, the light source 111E of the structured light generation unit 11E is a planar light source. As shown in FIG. 9, the light source 111E is an organic light emitting diode (OLED), and a light-emitting surface 1112 of the light source 111E is a curvy surface. It is noted that numerous modifications and alterations may be made while retaining the teachings of the invention. For example, in another embodiment, the light-emitting surface 1112 of the light source 111E is a flat surface.

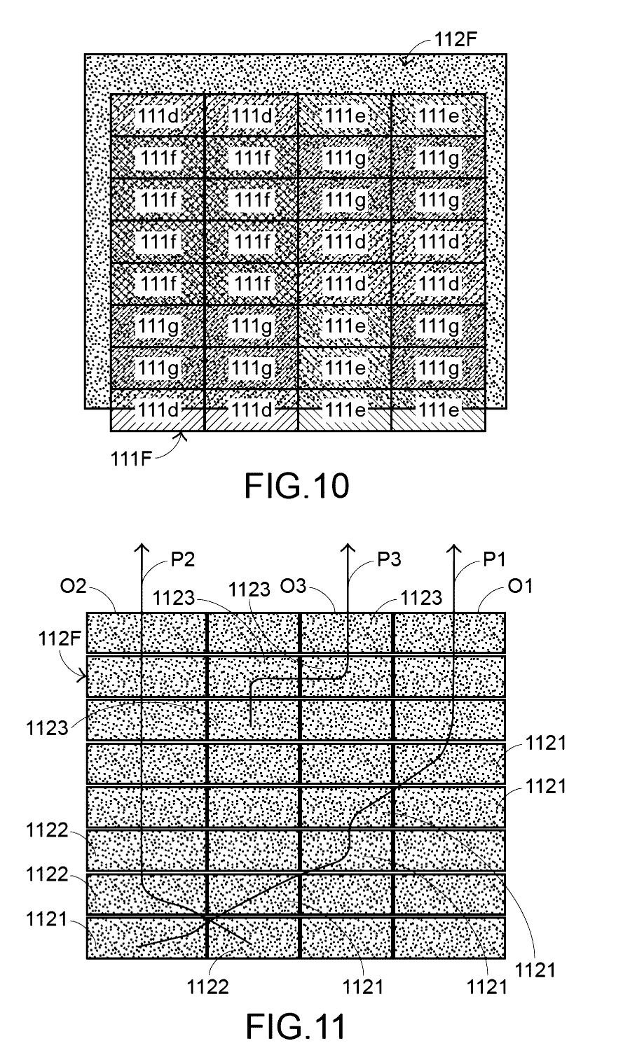

Please refer to FIGS. 10 and 11. FIG. 10 is a schematic view illustrating a structured light generation unit of an optical apparatus according to a sixth embodiment of the present invention. FIG. 11 is a schematic view illustrating the guided optical paths in the diffractive optical element of FIG. 10. The components of the optical apparatus of this embodiment which are similar to the optical devices of the above embodiments (e.g., from the second embodiment to the fifth embodiment) are not redundantly described herein. In comparison with the second embodiment to the fifth embodiment, the planar light source 111F is disposed under the diffractive optical element 112F. The planar light source 111F comprises plural lighting blocks for providing different color beams. In FIG. 10, the lighting block 111d is the lighting block for providing a first color beam, the lighting block 111e is the lighting block for providing a second color beam, lighting block 111f is the lighting block for providing a third color beam, and lighting block 111g is the lighting block for providing a fourth color beam. The diffractive optical element 112F is specially designed. Consequently, after the light beam (not shown) from each of the lighting blocks 111d˜111g is introduced into the diffractive optical element 112F, the light beam is guided along a predetermined optical path by the diffractive optical element 112F. Under this circumstance, the light beam from each of the lighting blocks 111d˜111g is outputted from a corresponding outlet of the diffractive optical element 112F.

Please refer to FIG. 11 again. After the light beam is introduced into the guiding block 1121 of the diffractive optical element 112F, the light beam is guided by the diffractive optical element 112F to be propagated along the optical path P1, and outputted from a lateral outlet O1 of the diffractive optical element 112F. After the light beam is introduced into the guiding block 1122 of the diffractive optical element 112F, the light beam is guided by the diffractive optical element 112F to be propagated along the optical path P2, and outputted from a lateral outlet O2 of the diffractive optical element 112F. After the light beam is introduced into the guiding block 1123 of the diffractive optical element 112F, the light beam is guided by the diffractive optical element 112F to be propagated along the optical path P3, and outputted from a lateral outlet O3 of the diffractive optical element 112F.

It is noted that numerous modifications and alterations may be made while retaining the teachings of the invention. For example, the color distribution of the lighting blocks of the light source, the guided optical paths in the diffractive optical element and the positions of the outlets may be modified according to the practical requirements.

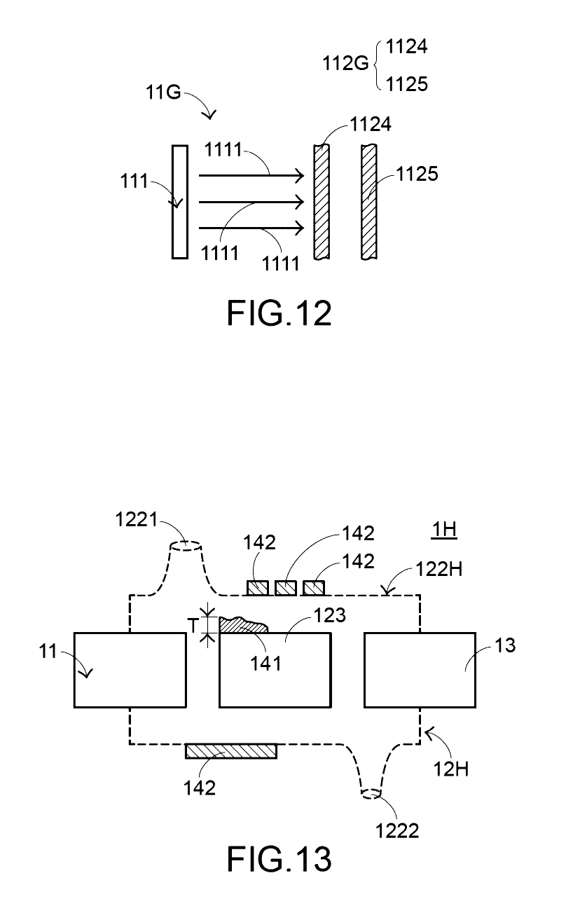

FIG. 12 is a schematic view illustrating a structured light generation unit of an optical apparatus according to a seventh embodiment of the present invention. The components of the optical apparatus of this embodiment which are similar to the optical devices of the above embodiments are not redundantly described herein. For clearly describing this embodiment, some components of the structured light generation unit 11G are not shown in FIG. 12. In the above embodiments, the diffractive optical element has a single-layered substrate. In this embodiment, the diffractive optical element 112G has plural substrates 1124 and 1125, which are in a stack arrangement. Preferably but not exclusively, the substrates 1124 and 1125 are optical diffractive films. When the light beams 1111 pass through the diffractive optical element 112G, the light beams 1111 are shaped by the diffractive optical element 112G. Consequently, the structured light (not shown) outputted from the structured light generation unit 11G can be flexibly adjusted.

FIG. 13 is a schematic view illustrating an optical apparatus according to an eighth embodiment of the present invention. The components of the optical apparatus of this embodiment which are similar to the optical devices of the above embodiments are not redundantly described herein. In comparison with the above embodiments, the optical apparatus 1H further comprises a heat treatment structure. Through the heat treatment structure, the heat generated by the optical apparatus 1H is dissipated by convection, conduction and/or radiation. Consequently, the optical apparatus 1H is applied to the wearable electronic device more suitably.

In this embodiment, the heat treatment structure comprises a first airflow port 1221, a second airflow port 1222, a thermal conduction part 141 and plural thermal radiation parts 142. The first airflow port 1221 and the second airflow port 1222 are formed in the casing 122H of the optical coupler 12H. The thermal conduction part 141 is attached on the coupling unit 123. The plural thermal radiation parts 142 are disposed on the casing 122H. Especially, the total area of the first airflow port 1221 and the total area of the second airflow port 1222 are different. As a consequence, the heat generated from the light source (not shown) can be dissipated by convection through the optical coupler 12H according to Bernoulli's principle.

Moreover, since the thermal conduction part 141 is attached on the coupling unit 123, the heat from the light source can be dissipated to the outside by conduction through the thermal conduction part 141. Preferably but not exclusively, the maximum thickness T of the thermal conduction part 141 is equal to or smaller than 15 mm. Moreover, since the plural thermal radiation parts 142 are disposed on the casing 122H, the heat can be dissipated by radiation through the thermal radiation parts 142. Preferably but not exclusively, these thermal radiation parts 142 are blackbody or near-black body. Moreover, the plural thermal radiation parts 142 are distributed in a dot array arrangement or a stripe array arrangement. The number, color and arrangement of the thermal radiation parts 142 are not restricted.

It is noted that numerous modifications and alterations may be made while retaining the teachings of the invention. For example, the number of the airflow ports or the shape and position of each airflow port may be modified or altered. Alternatively, the shape, number or position of the thermal conduction part may be modified or altered. For example, the thermal conduction part may be located beside a heat source other than the light source. In FIG. 13, the heat treatment structure is applied to the optical coupler 12H. It is noted that the application of the heat treatment structure is not restricted. That is, the heat treatment structure may be applied to other components of the optical apparatus according to the practical requirements.

From the above descriptions, the present invention provides the optical apparatus. After the light beams from the light source of the optical apparatus are shaped by the diffractive optical element, the light beams are introduced into the light transmission element. Consequently, the components between the light source and the light transmission element can be deployed more flexibly. Moreover, since the thickness of the diffractive optical element is smaller than 0.5 mm according to the conventional technology, the use of the diffractive optical element in the optical apparatus can reduce the optical loss during light transmission and increase the optical coupling between the light source and the light transmission element. Under this circumstance, the volume or the optical coupler for coupling the light source and the light transmission element and the overall volume of the optical apparatus are effectively reduced. In other words, since the use of the diffractive optical element can generate verified structured light patterns, more flexible optical coupling ways can be provided. In addition, the optical coupling efficiency is increased, and the overall volume of the optical apparatus is flexibly adjusted or reduced.

As mentioned above, the optical apparatus has small volume and excellent heat dissipation efficacy. The optical apparatus is suitably applied to a communication field, a security field, an entertainment field and a medical field, and suitably used in various wearable devices. Consequently, the optical apparatus of the present invention is industrially applicable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An optical apparatus, comprising:
a structured light generation unit outputting a structured light;
at least one light transmission element, wherein after plural first light beams of the structured light are introduced into the light transmission element, the first light beams are transferred within the light transmission element; and
an optical coupler, wherein the structured light generation unit and the at least one light transmission element are coupled with each other through the optical coupler.

2. The optical apparatus according to claim 1, wherein the structured light generation unit comprises a light source and an optical element group, wherein the optical element group comprises a diffractive optical element, a refractive optical element and/or a reflective optical element, wherein the light source provides plural second light beams, and the structured light is generated after the plural second light beams pass through the optical element group.

3. The optical apparatus according to claim 2, wherein the diffractive optical element has a single-layered substrate, or the diffractive optical element comprises plural substrates in a stack arrangement.

4. The optical apparatus according to claim 2, wherein the diffractive optical element comprises at least one optical diffractive film.

5. The optical apparatus according to claim 2, wherein a travelling direction of the plural second light beams is guided by the diffractive optical element, so that the plural second light beams are outputted from a corresponding outlet of a corresponding surface of the diffractive optical element.

6. The optical apparatus according to claim 2, wherein the light source at least comprises at least one light-emitting unit, and the at least one light-emitting unit comprises a laser diode (LD), a light emitting diode (LED) and/or an organic light emitting diode (OLED).

7. The optical apparatus according to claim 6, wherein the at least one light-emitting unit and the at least one light transmission element are in a one-to-one optical coupling arrangement, a one-to-multiple optical coupling arrangement or a multiple-to-multiple optical coupling arrangement.

8. The optical apparatus according to claim 2, wherein the plural second light beams from the light source have wavelengths in a first wavelength range, a second wavelength range and/or a thermal band.

9. The optical apparatus according to claim 2, wherein the light source comprises an organic light emitting diode with plural lighting blocks, and the plural second light beams comprise different color beams corresponding to the plural lighting blocks, wherein the diffractive optical element comprises plural guiding blocks, wherein after the plural second light beams are introduced into the diffractive optical element, the plural second light beams are guided by the corresponding guiding blocks along different optical paths and outputted from different positions of the diffractive optical element.

10. The optical apparatus according to claim 1, wherein the at least one light transmission element comprises at least one optical fiber.

11. The optical apparatus according to claim 1, further comprising a heat treatment structure, wherein heat generated from the optical apparatus is dissipated by convection, conduction and/or radiation through the heat treatment structure.

12. The optical apparatus according to claim 11, wherein the heat generated from the optical apparatus is dissipated by convection through the heat treatment structure according to Bernoulli's principle.

13. The optical apparatus according to claim 12, wherein the heat treatment structure comprises a first airflow port and a second airflow port, wherein a total area of the first airflow port and a total area of the second airflow port are different.

14. The optical apparatus according to claim 11, wherein the heat treatment structure comprises a thermal conduction part, and the heat generated from the optical apparatus is dissipated by conduction through the thermal conduction part, wherein a thickness of the thermal conduction part is equal to or smaller than 15 mm.

15. The optical apparatus according to claim 11, wherein the heat treatment structure comprises at least one thermal radiation part, and the heat generated from the optical apparatus is dissipated by radiation through the thermal radiation part.

16. The optical apparatus according to claim 1, wherein the optical apparatus is applied to a communication field, a security field, an entertainment field and/or a medical field.

17. The optical apparatus according to claim 1, wherein the optical apparatus is a wearable device.
